(19) United States
(12) Patent Application Publication
(10) Pub. No.: US 2026/0189710 A1
(43) Pub. Date: Jul. 2, 2026

(54) MULTI-MODAL COMMUNICATION DYNAMIC SWITCHING AND ADAPTIVE COMPRESSION SYSTEM AND METHOD FOR LOW-ALTITUDE INTELLIGENT NETWORK

(71) Applicant: Nanjing University of Aeronautics and Astronautics, Nanjing (CN)

(72) Inventors: Yuben QU, Nanjing (CN); Chao DONG, Nanjing (CN); Lei ZHANG, Nanjing (CN); Xi DENG, Nanjing (CN); Tianxing LIU, Nanjing (CN); Kunlun BU, Nanjing (CN); Qihui WU, Nanjing (CN)

(73) Assignee: Nanjing University of Aeronautics and Astronautics, Nanjing (CN)

(21) Appl. No.: 19/023,211

(22) Filed: Jan. 15, 2025

(30) Foreign Application Priority Data
Nov. 25, 2024 (CN) 202411688426.0

(51) Int. Cl. H04N 19/146; H04W 4/40

(52) U.S. Cl. CPC H04N 19/146; H04W 4/40

(57) ABSTRACT

A multi-modal communication dynamic switching and adaptive compression system and a method thereof for low-altitude intelligent network are provided. The system includes an airborne terminal and a ground terminal; the airborne terminal comprises a NVIDIA Jetson Xavier NX embedded computing platform, an airborne Raspberry Pi CM4-5G expansion board, an airborne ad hoc network radio, a flight control computer and an optical pod camera; the ground terminal comprises a ground Raspberry Pi CM4-5G expansion board and a ground ad hoc network radio; the multi-modal communication dynamic switching and adaptive compression system and the method thereof for low-altitude intelligent network provided by the invention take advantage of the advantages of longer transmission distance, no dependence on ground infrastructure and flexible deployment of the ad hoc network radio, and use it as a supplementary communication means of 5G public network, so as to ensure the real-time online of UAV.

### CROSS REFERENCE TO THE RELATED APPLICATIONS

This application is based upon and claims priority to Chinese Patent Application No. 202411688426.0, filed on Nov. 25, 2024, the entire contents of which are incorporated herein by reference.

### TECHNICAL FIELD

The invention belongs to the field of unmanned air vehicle(UAV) intelligent ad hoc network technology, especially relates to a multi-modal communication dynamic switching and adaptive compression system and a method thereof for low-altitude intelligent network.

### BACKGROUND

In current society, we are vigorously developing a low-altitude economy based on low-altitude airspace and led by the general aviation and UAV industry; the low-altitude economy is expected to become a typical representative of new quality productivity, it has broad application prospects in vertical industries such as emergency rescue, industry inspection, agricultural plant protection, public safety, geological exploration, environmental monitoring, film and television entertainment. It is expected to have a trillion-level market size. The development demand of low-altitude economy makes the low-altitude intelligent network emerge as the times require, the low-altitude intelligent network is an important infrastructure to realize the intelligent interconnection of a human-UAV-object ternary integration in the low-altitude airspace (3 km/1 km), which can help realize the physical network space of low-altitude business networking, digitization, and intelligent operation. By the end of 2023, China has 1.267 million real-name registered UAVs with a 32.2% year-on-year growth. In 2023, civil UAVs have flown a total of 23.11 million hours with an 11.8% year-on-year growth. Civil UAVs have achieved industry popularity in the fields of agriculture, forestry, animal husbandry, fishery, and entertainment aerial photography. As a key low-altitude new infrastructure, the low-altitude intelligent network is an essential basic information network facility to support low-altitude economic development. Due to the lack of low-altitude basic network facilities, the feasible way is to slightly transform the ground communication facilities (such as upgrading the existing base station software) or build a small number of low-altitude communication base stations to achieve low-altitude three-dimensional network coverage. However, in general, it is not enough to rely solely on traditional ground cellular network facilities. How to realize the real-time online networking (continuous line) of low-altitude aircraft such as UAVs and the corresponding efficient backhaul of data is a key issue that needs to be solved urgently in low-altitude intelligent network, which is crucial for the take-off of low-altitude economy.

To this end, the invention designs a multi-modal communication dynamic switching and adaptive compression system and method for low-altitude intelligent network, which can bring more technological innovation and application expansion possibilities for the communication coverage and computing power supply of low-altitude intelligent network.

### SUMMARY

The purpose of the invention is to provide a multi-modal communication dynamic switching and adaptive compression system and a method thereof for low-altitude intelligent network, and to solve the problems of traditional UAV inspection systems relying on manual operation, insufficient real-time transmission and limited airborne computing power in existing technologies.

To achieve the above purposes, the invention provides a multi-modal communication dynamic switching and adaptive compression system for low-altitude intelligent network, including an airborne terminal and a ground terminal; the airborne terminal includes an NVIDIA Jetson Xavier NX embedded computing platform, an airborne Raspberry Pi CM4-5G expansion board, an airborne ad hoc network radio, a flight control computer, and an optical pod camera; the ground terminal includes a ground Raspberry Pi CM4-5G expansion board and a ground ad hoc network radio.

Preferably, the NVIDIA Jetson Xavier NX embedded computing platform is equipped with a target detection model, a video compression module, a network state sensing module, a data transmission module, and a route intelligent planning module.

Preferably, the target detection model adopts a structure of a you only look once v5 (YOLOv5) network, after training by several UAV aerial image samples, the YOLOv5 network divides an input image into grids of different sizes, and predicts a bounding box and a category of a target in each grid for target detection; during a training process, according to a feedback of a loss function, the YOLOv5 network adjusts a weight to optimize performance and accuracy of the target detection model, a detection video is output during a detection process for subsequent processing.

Preferably, the video compression module performs video compression by calling a ffmpeg tool in the airborne Raspberry Pi CM4-5G expansion board and adjusts a compression rate by adjusting a conditional random field (CRF) value during video transmission, a CRF parameter is used to control a video quality of a H.264 coding, CRF is the abbreviation of Constant Rate Factor, CRF is a quantitative parameter used to control the compression rate and quality of video coding. The CRF value ranges from 0 to 51, where 0 represents lossless compression (i.e., original video quality), 51 represents the lowest quality and the highest compression rate, and the CRF value is inversely proportional to video quality and file size. Specifically, in general, when the CRF value is smaller, the video quality is higher, but the file size is larger; when the CRF value is larger, the video quality is lower and the file size is smaller.

Preferably, the ground Raspberry Pi CM4-5G expansion board is used to establish an ad hoc network between ground and a UAV and a 5G connection, sensing a connection state of a current link in real-time, switches a data transmission link through the connection state, and transmits a current transmission quality to the NVIDIA Jetson Xavier NX embedded computer, so that the video compression is performed according to this value; and the ground Raspberry Pi CM4-5G expansion board uses an integrated 5G module to complete a connection of 5G links, at the same time, the ground ad hoc network radio is connected through a network port to complete a connection of the ad hoc network link with the airborne ad hoc network radio, and uses the ground Raspberry Pi CM4-5G expansion board to complete a reading and decompression of transmitted video data and play the video in real-time.

Preferably, the airborne Raspberry Pi CM4-5G expansion board is used to sense a connection quality of two links, and then transmits data to the NVIDIA Jetson Xavier NX embedded computer, the NVIDIA Jetson Xavier NX embedded computer compresses the video, after the compression is completed, the compressed video is transmitted to the ground terminal through the airborne Raspberry Pi CM4-5G expansion board, the two links are ad hoc network link and 5G link respectively.

Preferably, both the ground ad hoc radio and the airborne ad hoc radio are used t establish ad hoc network links at the airborne and ground terminals.

The invention also provides a multi-modal communication dynamic switching and adaptive compression method for low-altitude intelligent network, including the following steps:
Step 1: Establishing a communication connection between the airborne terminal and the ground terminal, sensing quality information of the two communication links in real-time by the airborne Raspberry Pi CM4-5G expansion board and the ground Raspberry Pi CM4-5G expansion board;
Step 2: Specifying a starting point and an end point of a UAV flight, planning a flight path independently by the NVIDIA Jetson Xavier NX embedded computer according to the environmental conditions, and transmitting path information to the flight control computer;
Step 3: During a UAV cruise, capturing the video data in real-time by a mounted optical pod camera, and then transmitting the video data to the NVIDIA Jetson Xavier NX embedded computer;
Step 4: Obtaining link quality information transmitted by the airborne Raspberry Pi CM4-5G expansion board by the NVIDIA Jetson Xavier NX embedded computer, determining the compression rate of the transmitted video through the data, compressing the video data taken in Step 3, and transmitting the video data to the airborne Raspberry Pi CM4-5G expansion board after compression;
Step 5: Selecting the video transmission link according to the connection of the current two links by the airborne Raspberry Pi CM4-5G expansion board and the ground Raspberry Pi CM4-5G expansion board, and transmitting the video data from a selected link to the ground Raspberry Pi CM4-5G expansion board.
Step 6: After receiving the compressed video data, decompressing the compressed video and displaying the compressed video by the ground Raspberry Pi CM4-5G expansion board in real-time.

Preferably, the specific process of Step 4 is as follows:
S41, transmitting collected video data to the NVIDIA Jetson Xavier NX embedded computer by the optical pod camera;
S42, obtaining the link quality information transmitted by the airborne Raspberry Pi CM4-5G expansion board by the NVIDIA Jetson Xavier NX embedded computer, and determining the compression rate of the transmitted video through the data;
S43, dividing a video compression rate into four levels, when a signal-to-noise ratio of the link is lower than 50 dB, the CRF value of the video compression is 30; when the signal-to-noise ratio is 30 dB to 60 dB, the CRF value is 28; when the signal-to-noise ratio is 60 dB to 70 dB, the CRF value is 26; when the signal-to-noise ratio is above 70 dB, the CRF value is 24;
S44, after the video compression is completed, transmitting the compressed video data to the airborne Raspberry Pi CM4-5G expansion board by the NVIDIA Jetson Xavier NX embedded computer;
S45, after receiving the data, transmitting the data to the ground Raspberry Pi CM4-5G expansion board by the airborne Raspberry Pi CM4-5G expansion board through the established link.

Preferably, a process of selecting the video transmission link in Step 5 is as follows:
S51, when a program is started, defining a communication address, the ad hoc network link adopts a fixed IPv4 address, and addresses at both terminals are 192.168.17.100 and 192.168.17.101, respectively; for a 5G link, due to a particularity of the 5G network, an IPv6 address of the link is randomly assigned each time the system is powered on, so the addresses at both terminals are not fixed;
S52, after the system starts, reading the IPv6 address of the terminal and recording for communication;
S53, setting up a timer function, the timer function sends a message information for building connection to an address of the other party every m seconds, the message information for building connection is called heartbeat packet;
S54, real-time capturing the heartbeat packet sent by the other party, and counting received heartbeat packets, when receiving a new heartbeat packet, resetting a counter to keep the value of the counter to 0;
S55, if the system does not receive the heartbeat packet sent by the other party within a predetermined time, the value of the counter will gradually increase;
S56, when the value of the counter reaches a preset threshold (for example, the heartbeat packet is not received for several seconds), judging that a current communication link is failed;
S57, when the link fails, printing link failure information automatically, and triggering a link switching mechanism to switch the data transmission to a standby link that can work normally;
S 58, if the ad hoc network link fails, the system attempts to use the 5G link for data transmission; and vice versa;
S59, after the link failure is detected, performing a link switching immediately by the system, redefining a communication address, rebuilding a connection with the other party, and maintaining to send and receive data;
S60, during a switching process, monitoring a state of a new link by the system continuously and further performing an adjustment according to an actual situation;
S61, if a failed link returns to normal after a period, the system will re-capture the heartbeat packet sent by the other party and rebuild a connection of the link;
S62, according to a priority of the link and current communication conditions, determining whether to switch the data transmission back to a recovered link, to optimize data transmission efficiency.

Therefore, the invention adopts the above-mentioned multi-modal communication dynamic switching and adaptive compression system and a method thereof for low-altitude intelligent network, which has the following beneficial effects:
(1) Sensory transmission, calculation, and control are integrated to adapt to different perceptual loads. The invention carries the embedded AI computer to the UAV, and uses the airborne embedded AI computer to first carry out preliminary detection and identification, which is expected to improve the processing accuracy and reliability while reducing the amount of returned data. At the same time, aiming at the problem that the traditional UAV inspection system relies on manual operation, this system combines the UAV intelligent path planning system to improve the intelligence of the whole system. Finally, the integration of sensing, transmission, calculation, and control is realized, which effectively solves the problems of insufficient real-time transmission and limited airborne computing power.
(2) A variety of communication methods are integrated into the continuous line to ensure efficient data backhaul while improving security. Considering that the ad hoc network has the advantages of longer transmission distance, no dependence on ground infrastructure, and flexible deployment, the invention adopts the method of integrating the 5G public network and ad hoc network into UAV, and uses ad hoc network as a supplementary means of the 5G public network to meet the needs of transmission distance and signal coverage, to ensure that UAV is almost all-weather online.
(3) Intelligent sensing switching. In the face of increasingly complex scenarios, the processing and management capabilities that rely on traditional manual rules to pre-define and execute have gradually failed to meet the needs, therefore, the invention organically integrates the ad hoc network with 5G, so that both terminals can sense the connection quality of the two communication links in real-time, and according to the quality information, an automated and intelligent system and means are used to intelligently switch the current communication mode to achieve a high degree of connection between devices.
(4) Intelligent perception and processing of airborne data, adaptive compression of video data after initial detection. The invention is equipped with an embedded intelligent computing system on the UAV, the preprocessing function is added based on the original acquisition and transmission information function of the UAV, by sensing the real-time connection state of the link, the video data obtained by the optical pod camera is initially detected and then adaptively compressed, thereby reducing the amount of backhaul data, reducing the bandwidth consumed by propagation, and improving the accuracy of information propagation.
(5) UAV autonomous path planning. By optimizing the flight route, the efficiency of mission execution is improved, and the flight time and energy consumption are reduced. At the same time, it can enhance flight safety, so that the UAV can automatically avoid obstacles and reduce the risk of collision. While effectively reducing the dependence on manual operation, the UAV can adapt to environmental changes and emergencies in real-time and adapt to a variety of application scenarios.

The following is a further detailed description of the technical scheme of the invention through drawings and an embodiment.

### BRIEF DESCRIPTION OF THE DRAWINGS

FIG. 1 is a structural diagram of the multi-modal communication dynamic switching and adaptive compression system for low-altitude intelligent network in this invention.

FIG. 2 is an overall flow chart of the multi-modal communication dynamic switching and adaptive compression system for low-altitude intelligent network in this invention.

FIG. 3 is a link-switching flow chart of the embodiment of the invention;

FIG. 4 is an application hierarchy diagram of the invention.

### DETAILED DESCRIPTION OF THE EMBODIMENTS

The following detailed description of the embodiment of the invention provided in the accompanying figures is not intended to limit the scope of the invention requiring protection, but merely indicates the selected embodiment of the invention. Based on the embodiment in this invention, all other embodiments obtained by ordinary technicians in this field without making creative labor belong to the scope of protection of this invention.

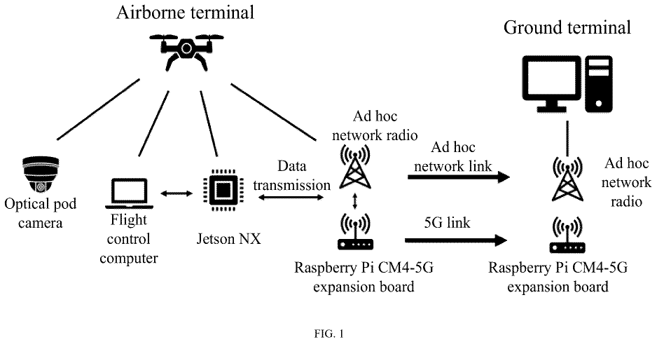

Please refer to FIG. 1, a multi-modal communication dynamic switching and adaptive compression system for low-altitude intelligent network, including an airborne terminal and a ground terminal; the airborne terminal includes an NVIDIA Jetson Xavier NX embedded computing platform, an airborne Raspberry Pi CM4-5G expansion board, an airborne ad hoc network radio, a flight control computer, and an optical pod camera; this part connects the NVIDIA NX development board, the airborne Raspberry Pi CM4-5G expansion board and a wireless transceiver module for connecting the ad hoc network into a system through a network switch and a network port. The video compression part of the system uses the JetsonNX development board produced by NVIDIA to provide AI computing capabilities for the UAV system, its AI computing power reaches 100TOPS, and its performance is brilliant, it is suitable for various unmanned system perception scenarios, it can realize online detection and identification of UAVs and adaptive compression of video by sensing the state of the link. At the same time, it is equipped with an airborne Raspberry Pi CM4-5G expansion board to connect the 5G communication module and the ad hoc network module, the 5G signal is received by the 5G antenna integrated on the airborne Raspberry Pi CM4, and the ad hoc network information is received by the wireless receiving module connected to the airborne Raspberry Pi CM4-5G expansion board through the switch. The module mainly plays the role of a transfer station, during the working process, it can sense and judge the connection status of the two links in real-time, and independently select the transmission link according to the connection situation, providing a high-speed and stable wireless connection for our devices, the data transmission speed and network response performance are improved and the direct communication between devices and network self-management is achieved.

The ground terminal includes a ground Raspberry Pi CM4-5G expansion board and a ground ad hoc network radio; the two parts are connected through a network port. Its function is similar to that of the airborne Raspberry Pi CM4-5G expansion board, the expansion board transmits and exchanges the 5G data through the integrated 5G antenna, and the ground ad hoc network data is received by the ad hoc network radio connected by the network port, the ground ad hoc network radio is paired with the wireless receiving device carried by the airborne terminal to ensure the terminal-to-terminal data transmission between the two devices. After receiving the compressed video data, the ground Raspberry Pi CM4-5G expansion board can be used for reorganizing the data packets and restoring the compressed image video. The target detection model, video compression module, network state sensing module, data transmission module, and route intelligent planning module are installed in the NVIDIA Jetson Xavier NX embedded computing platform. The route intelligent planning module can comprehensively consider factors such as arrival time, fuel consumption, threat, and flightable area, and plan the optimal or sub-optimal flight trajectory for the flight of the UAV. Combining the intelligent algorithm based on artificial intelligence technology with autonomous route planning can effectively avoid the shortcomings of the traditional trajectory planning algorithm and achieve dynamic response; the target detection model adopts the YOLOv5 network structure and is trained by several UAV aerial image samples, the YOLOv5 network performs target detection by dividing the input image into grids of different sizes and predicting the bounding box and category of the target in each grid; during the training process, according to the feedback of the loss function, the YOLOv5 network adjusts its weight to optimize the performance and accuracy of the model. The detection video is output during the detection process for subsequent processing. The video compression module performs video compression by calling the ffmpeg tool in the airborne Raspberry Pi CM4-5G expansion board, and adjusts the compression rate by adjusting the CRF value during video transmission, the CRF parameter is used to control the video quality of H.264 coding, CRF is the abbreviation of Constant Rate Factor, CRF is a quantitative parameter used to control the compression rate and quality of video coding. The CRF value ranges from 0 to 51, where 0 represents lossless compression (i.e., original video quality), 51 represents the lowest quality and the highest compression rate, and the CRF value is inversely proportional to video quality and file size. Specifically, in general, when the CRF value is smaller, the video quality is higher, but the file size is larger; when the CRF value is larger, the video quality is lower and the file size is smaller. The ground Raspberry Pi CM4-5G expansion board is used to establish an ad hoc network and 5G connection between the ground and the UAV. It senses the connection status of the current link in real-time, switches the data transmission link through the status, and transmits the current transmission quality to the NVIDIA Jetson Xavier NX embedded computer to perform video compression according to the value. The ground Raspberry Pi CM4-5G expansion board uses the integrated 5G module to complete the connection of the 5G link, at the same time, the ground ad hoc network radio is connected to the airborne ad hoc network radio through the network port to complete the connection of the ad hoc network link, and the airborne ad hoc network radio is used to complete the reading of the transmitted video data for real-time playback. The airborne Raspberry Pi CM4-5G expansion board is used to sense the connection quality of the two links, and then transmit the data to the NVIDIA Jetson Xavier NX embedded computer, the NVIDIA Jetson Xavier NX embedded computer compresses the video, after the compression is completed, it is transmitted to the ground terminal through the airborne Raspberry Pi CM4-5G expansion board, the two links are the ad hoc network link and the 5G link; the problem of large signal fluctuation range in the UAV scenario is fully considered, at present, the 5G communication has the disadvantages of small base station coverage, low overall coverage, and expensive cost, the wireless ad hoc network has the advantages of longer transmission distance, no dependence on ground infrastructure, and flexible deployment, it can be used as a supplementary communication method for 5G public network to ensure the real-time online of UAV. The ground ad hoc network radio and airborne ad hoc network radio are used to establish ad hoc network links at the airborne terminal and the ground terminal.

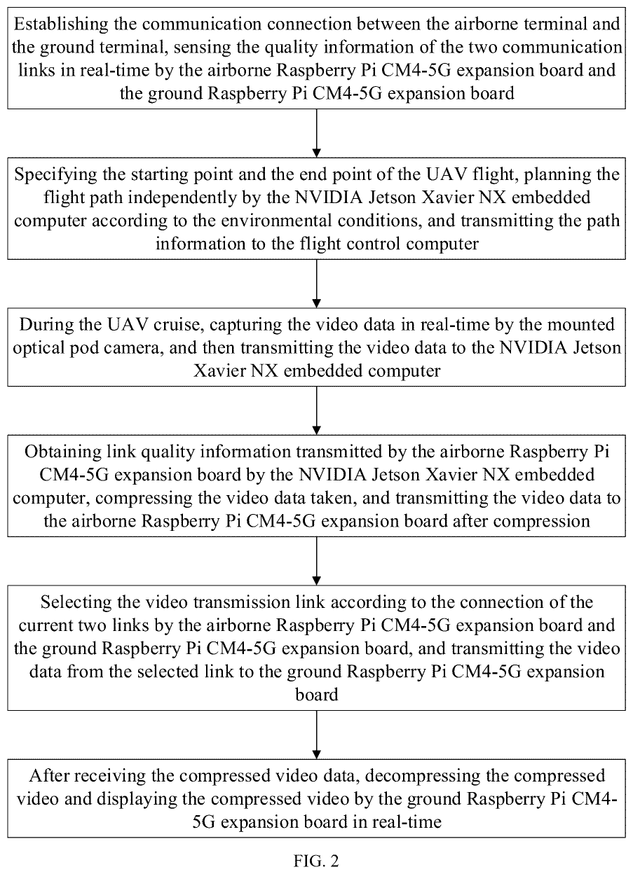

Please refer to FIG. 2, the multi-modal communication dynamic switching and adaptive compression method for low-altitude intelligent network, including the following steps:
Step 1: A communication connection is established between the airborne terminal and the ground terminal, the airborne Raspberry Pi CM4-5G expansion board and the ground Raspberry Pi CM4-5G expansion board sense the quality information of the two communication links in real-time;
Step 2: The starting point and the end point of the UAV flight are specified, the flight path is planned independently by the NVIDIA Jetson Xavier NX embedded computer according to the environmental conditions, and the path information is transmitted to the flight control computer;
Step 3: During the UAV cruise, the mounted optical pod camera captures the video data in real-time, and then the video data is transmitted to the NVIDIA Jetson Xavier NX embedded computer;
Step 4: The NVIDIA Jetson Xavier NX embedded computer obtains the link quality information transmitted by the airborne Raspberry Pi CM4-5G expansion board, and the compression rate of the transmitted video is determined through the data, the video data taken in Step 3 are compressed, and the video data are transmitted to the airborne Raspberry Pi CM4-5G expansion board after compression; the specific process is as follows:
S41, the optical pod camera transmits the collected video data to the NVIDIA Jetson Xavier NX embedded computer;
S42, the NVIDIA Jetson Xavier NX embedded computer obtains the link quality information transmitted by the airborne Raspberry Pi CM4-5G expansion board, and the compression rate of the transmitted video is determined through the data;
S43, the video compression rate is divided into four levels, when the signal-to-noise ratio of the link is lower than 50 dB, the CRF value of the video compression is 30; when the signal-to-noise ratio is 30 dB to 60 dB, the CRF value is 28; when the signal-to-noise ratio is 60 dB to 70 dB, the CRF value is 26; when the signal-to-noise ratio is above 70 dB, the CRF value is 24;

S44, after the video compression is completed, the NVIDIA Jetson Xavier NX embedded computer transmits the compressed video data to the airborne Raspberry Pi CM4-5G expansion board;

S45, after receiving the data, the airborne Raspberry Pi CM4-5G expansion board transmits the data to the ground Raspberry Pi CM4-5G expansion board through the established link.

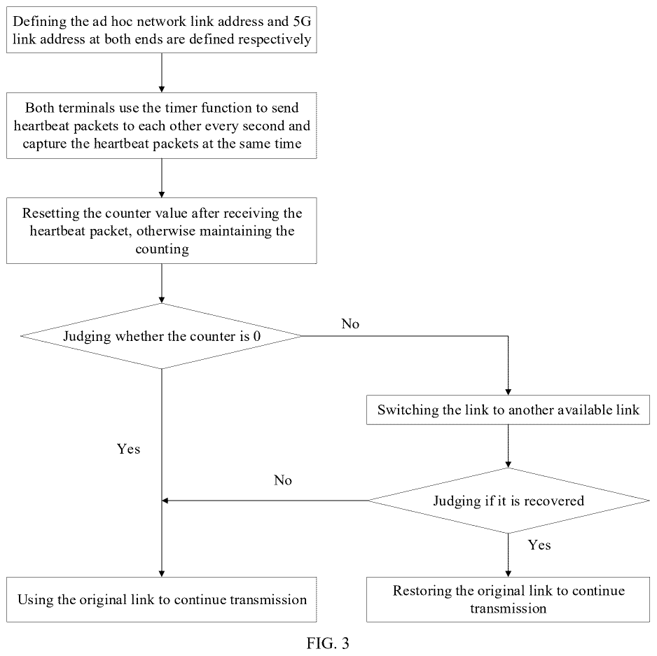

Step 5: The airborne Raspberry Pi CM4-5G expansion board and the ground Raspberry Pi CM4-5G expansion board select the video transmission link according to the connection of the current two links, and the video data are transmitted from the selected link to the ground Raspberry Pi CM4-5G expansion board; where the process of selecting the video transmission link is shown in FIG. 3, as follows:
S51, when the program is started, the communication address is defined, the ad hoc network link adopts a fixed IPv4 address, and addresses at both terminals are 192.168.17.100 and 192.168.17.101, respectively; for a 5G link, due to the particularity of the 5G network, the IPv6 address of the link is randomly assigned each time the system is powered on, so the addresses at both terminals are not fixed;
S52, after the system starts, the IPv6 address of the terminal is read and recorded for communication;
S53, a timer function is set up, the timer function sends the message information for building a connection to the address of the other party every m seconds(m=1), the message information for building the connection is called heartbeat packet;
S54, the heartbeat packet sent by the other party is captured in real-time, and the received heartbeat packets are counted, when receiving a new heartbeat packet, the counter is reset to keep the value of the counter to 0;
S55, if the system does not receive the heartbeat packet sent by the other party within the predetermined time, the value of the counter will gradually increase;
S56, when the value of the counter reaches a preset threshold (for example, the heartbeat packet is not received for several seconds), the current communication link is judged to be failed;
S57, when the link fails, the link failure information is printed automatically, and the link switching mechanism is triggered to switch the data transmission to the standby link that can work normally;
S58, if the ad hoc network link fails, the system attempts to use the 5G link for data transmission; and vice versa;
S59, after the link failure is detected, the system performs a link switching immediately, redefines a communication address, rebuilds a connection with the other party, and maintains to send and receive data;
S60, during the switching process, the system monitors the state of the new link continuously and a further adjustment is performed according to the actual situation;
S61, if the failed link returns to normal after a period, the system will re-capture the heartbeat packet sent by the other party and rebuild the connection of the link;
S62, according to the priority of the link and the current communication conditions, whether to switch the data transmission back to the recovered link is determined, to optimize the data transmission efficiency.

Step 6: After receiving the compressed video data, the ground Raspberry Pi CM4-5G expansion board decompresses the compressed video and displays the compressed video in real-time.

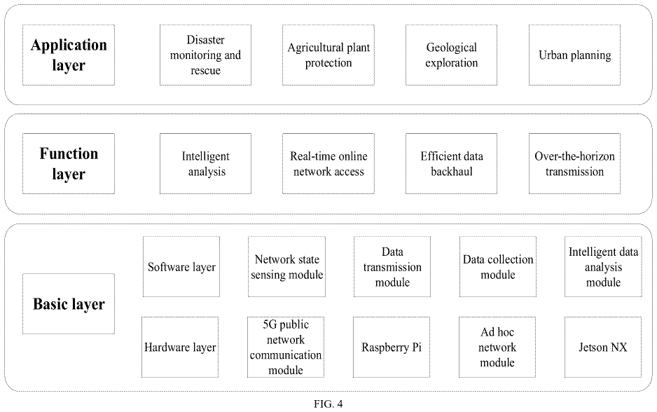

As shown in FIG. 4, in the specific application, the whole system is divided into three layers, including an application layer, a function layer, and a base layer; the details are as follows:

Application layer: According to the basic data and the operation data provided by the infrastructure layer, this layer can provide various business applications, including disaster monitoring and rescue, agricultural plant protection, geological exploration, and urban planning.

Function layer: This layer implements various functions in the operation of the system, mainly including intelligent analysis (analysis of collected data), real-time online network access (to ensure the stability of the network), efficient data backhaul (less bandwidth consumption), and over-the-horizon transmission.

Basic layer: This layer provides basic support for various functions in the operation of the system and internal and external information exchange. It includes software resources such as the network state sensing module, the data transmission module, the data collection module, and the intelligent data analysis module, as well as hardware resources such as the 5G public network communication module, the Raspberry Pi, the NVIDIA chip and the ad hoc network module.

Therefore, the invention adopts the above-mentioned multi-modal communication dynamic switching and adaptive compression system and method thereof for low-altitude intelligent network, integrates the basic public load of functions such as sensing, namely, sensing transmission link quality, transmission, namely, 5G+ ad hoc network link dual-link transmission, calculation, namely, intelligent video compression algorithm, control, namely, UAV autonomous path planning, etc., and uses 5G technology, ad hoc network technology, and airborne embedded AI computer to integrate various advantages, to reduce the amount of backhaul data, reduce the bandwidth consumed by transmission, and improve the accuracy of information transmission and adapt to a variety of application scenarios.

Finally, it should be explained that the above embodiment is only used to explain the technical scheme of the invention rather than restrict it, although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A multi-modal communication dynamic switching and adaptive compression system for a low-altitude intelligent network, comprising an airborne terminal and a ground terminal; wherein the airborne terminal comprises an NVIDIA Jetson Xavier NX embedded computing platform, an airborne Raspberry Pi CM4-5G expansion board, an airborne ad hoc network radio, a flight control computer, and an optical pod camera; and the ground terminal comprises a ground Raspberry Pi CM4-5G expansion board and a ground ad hoc network radio.

2. The multi-modal communication dynamic switching and adaptive compression system according to claim 1, wherein the NVIDIA Jetson Xavier NX embedded computing platform is equipped with a target detection model, a video compression module, a network state sensing module, a data transmission module, and a route intelligent planning module.

3. The multi-modal communication dynamic switching and adaptive compression system according to claim 2, wherein the target detection model adopts a structure of a you only look once v5 (YOLOv5) network, after training by a plurality of unmanned air vehicle (UAV) aerial image samples, the YOLOv5 network divides an input image into grids of different sizes, and predicts a bounding box and a category of a target in each of the grids for target detection.

4. The multi-modal communication dynamic switching and adaptive compression system according to claim 3, wherein the video compression module performs a video compression by calling a ffmpeg tool in the airborne Raspberry Pi CM4-5G expansion board, and adjusts a compression rate by adjusting a conditional random field (CRF) value during a video transmission, the CRF value is used to control a video quality of an H.264 encoding, the CRF value ranges from 0 to 51, wherein 0 represents a lossless compression, 51 represents a lowest quality and a highest compression rate, and the CRF value is inversely proportional to the video quality and a file size.

5. The multi-modal communication dynamic switching and adaptive compression system according to claim 4, wherein the ground Raspberry Pi CM4-5G expansion board is used to establish an ad hoc network between ground and a UAV and a 5G connection, senses a connection state of a current link in real time, switches a data transmission link through the connection state, and transmits a current transmission quality to the NVIDIA Jetson Xavier NX embedded computing platform, so that the video compression is performed according to the current transmission quality; and the ground Raspberry Pi CM4-5G expansion board uses an integrated 5G module to complete a connection of 5G links, at the same time, the ground ad hoc network radio is connected through a network port to complete a connection of an ad hoc network link with the airborne ad hoc network radio, and uses the ground Raspberry Pi CM4-5G expansion board to complete a reading and a decompression of transmitted video data, and play the transmitted video data in real time.

6. The multi-modal communication dynamic switching and adaptive compression system according to claim 5, wherein the airborne Raspberry Pi CM4-5G expansion board is used to sense a connection quality of two links, and then transmits data to the NVIDIA Jetson Xavier NX embedded computing platform, the NVIDIA Jetson Xavier NX embedded computing platform compresses a video, after a compression is completed, a compressed video is transmitted to the ground terminal through the airborne Raspberry Pi CM4-5G expansion board, and the two links are the ad hoc network link and the 5G link respectively.

7. The multi-modal communication dynamic switching and adaptive compression system according to claim 6, wherein both the ground ad hoc network radio and the airborne ad hoc network radio are used to establish the ad hoc network links at the airborne terminal and the ground terminal.

8. A method of the multi-modal communication dynamic switching and adaptive compression system according to claim 1, comprising the following steps:
step 1: establishing a communication connection between the airborne terminal and the ground terminal, and sensing quality information of two communication links in real-time by the airborne Raspberry Pi CM4-5G expansion board and the ground Raspberry Pi CM4-5G expansion board;
step 2: specifying a starting point and an end point of a UAV flight, planning a flight path independently by the NVIDIA Jetson Xavier NX embedded computing platform according to environmental conditions, and transmitting path information to the flight control computer;
step 3: during a UAV cruise, capturing video data in real-time by the optical pod camera, and then transmitting the video data to the NVIDIA Jetson Xavier NX embedded computing platform;
step 4: obtaining link quality information transmitted by the airborne Raspberry Pi CM4-5G expansion board by the NVIDIA Jetson Xavier NX embedded computing platform, determining a compression rate of transmitted video through data, compressing the video data taken in the step 3, and transmitting the video data to the airborne Raspberry Pi CM4-5G expansion board after compression;
step 5: selecting a video transmission link according to a connection of current two links by the airborne Raspberry Pi CM4-5G expansion board and the ground Raspberry Pi CM4-5G expansion board, and transmitting the video data from a selected link to the ground Raspberry Pi CM4-5G expansion board; and
step 6: after receiving compressed video data, decompressing the compressed video data and displaying the compressed video data by the ground Raspberry Pi CM4-5G expansion board in real-time.

9. The method according to claim 8, wherein a process of the step 4 is as follows:
S41, transmitting collected video data to the NVIDIA Jetson Xavier NX embedded computing platform by the optical pod camera;
S42, obtaining the link quality information transmitted by the airborne Raspberry Pi CM4-5G expansion board by the NVIDIA Jetson Xavier NX embedded computing platform, and determining the compression rate of the transmitted video through the data;
S43, dividing a video compression rate into four levels, when a signal-to-noise ratio of a link is lower than 50 dB, a CRF value of a video compression is 30; when the signal-to-noise ratio is 30 dB to 60 dB, the CRF value is 28; when the signal-to-noise ratio is 60 dB to 70 dB, the CRF value is 26; and when the signal-to-noise ratio is above 70 dB, the CRF value is 24;
S44, after the video compression is completed, transmitting the compressed video data to the airborne Raspberry Pi CM4-5G expansion board by the NVIDIA Jetson Xavier NX embedded computing platform; and
S45, after receiving the compressed video data, transmitting the compressed video data to the ground Raspberry Pi CM4-5G expansion board by the airborne Raspberry Pi CM4-5G expansion board through an established link.

10. The method according to claim 9, wherein a process of selecting the video transmission link in the step 5 is as follows:
S51, when a program is started, defining a communication address, wherein an ad hoc network link adopts a fixed IPv4 address, for a 5G link, an IPv6 address of the 5G link is randomly assigned;
S52, after the multi-modal communication dynamic switching and adaptive compression system starts, reading the IPv6 address of a terminal and recording for communication;
S53, setting up a timer function, wherein the timer function sends message information for building a connection to an address of the other party every m seconds, and the message information for building the connection is called a heartbeat packet;
S54, real-time capturing the heartbeat packet sent by the other party, counting received heartbeat packets, and when receiving a new heartbeat packet, resetting a counter to keep a value of the counter to 0;
S55, when the multi-modal communication dynamic switching and adaptive compression system does not receive the heartbeat packet sent by the other party within a predetermined time, allowing the value of the counter to gradually increase;
S56, when the value of the counter reaches a preset threshold, judging that a current communication link has failed;
S57, when the current communication link fails, printing link failure information automatically, and triggering a link switching mechanism to switch a data transmission to a standby link configured to work normally;
S58, when the ad hoc network link fails, allowing the multi-modal communication dynamic switching and adaptive compression system to attempt to use the 5G link for the data transmission; and when the 5G link fails, allowing the multi-modal communication dynamic switching and adaptive compression system to attempt to use the ad hoc network link for the data transmission;
S59, after a link failure is detected, performing a link switching immediately by the multi-modal communication dynamic switching and adaptive compression system, redefining the communication address, rebuilding the connection with the other party, and maintaining to send and receive the data;
S60, during a switching process, monitoring a state of a new link by the multi-modal communication dynamic switching and adaptive compression system continuously and further performing an adjustment according to an actual situation;
S61, when a failed link returns to normal after a period, allowing the multi-modal communication dynamic switching and adaptive compression system to re-capture the heartbeat packet sent by the other party and rebuild the connection of the link; and
S62, according to a priority of the link and current communication conditions, determining whether to switch the data transmission back to a recovered link, so as to optimize a data transmission efficiency.

11. The method according to claim 8, wherein in the multi-modal communication dynamic switching and adaptive compression system, the NVIDIA Jetson Xavier NX embedded computing platform is equipped with a target detection model, a video compression module, a network state sensing module, a data transmission module, and a route intelligent planning module.

12. The method according to claim 11, wherein in the multi-modal communication dynamic switching and adaptive compression system, the target detection model adopts a structure of a YOLOv5 network, after training by a plurality of UAV aerial image samples, the YOLOv5 network divides an input image into grids of different sizes, and predicts a bounding box and a category of a target in each of the grids for target detection.

13. The method according to claim 12, wherein in the multi-modal communication dynamic switching and adaptive compression system, the video compression module performs a video compression by calling a ffmpeg tool in the airborne Raspberry Pi CM4-5G expansion board, and adjusts the compression rate by adjusting a CRF value during a video transmission, the CRF value is used to control a video quality of an H.264 encoding, the CRF value ranges from 0 to 51, wherein 0 represents a lossless compression, 51 represents a lowest quality and a highest compression rate, and the CRF value is inversely proportional to the video quality and a file size.

14. The method according to claim 13, wherein in the multi-modal communication dynamic switching and adaptive compression system, the ground Raspberry Pi CM4-5G expansion board is used to establish an ad hoc network between ground and a UAV and a 5G connection, senses a connection state of a current link in real time, switches a data transmission link through the connection state, and transmits a current transmission quality to the NVIDIA Jetson Xavier NX embedded computing platform, so that the video compression is performed according to the current transmission quality; and the ground Raspberry Pi CM4-5G expansion board uses an integrated 5G module to complete a connection of 5G links, at the same time, the ground ad hoc network radio is connected through a network port to complete a connection of an ad hoc network link with the airborne ad hoc network radio, and uses the ground Raspberry Pi CM4-5G expansion board to complete a reading and a decompression of transmitted video data, and play the transmitted video data in real time.

15. The method according to claim 14, wherein in the multi-modal communication dynamic switching and adaptive compression system, the airborne Raspberry Pi CM4-5G expansion board is used to sense a connection quality of two links, and then transmits the data to the NVIDIA Jetson Xavier NX embedded computing platform, the NVIDIA Jetson Xavier NX embedded computing platform compresses a video, after the compression is completed, a compressed video is transmitted to the ground terminal through the airborne Raspberry Pi CM4-5G expansion board, and the two links are the ad hoc network link and the 5G link respectively.

16. The method according to claim 15, wherein in the multi-modal communication dynamic switching and adaptive compression system, both the ground ad hoc network radio and the airborne ad hoc network radio are used to establish the ad hoc network links at the airborne terminal and the ground terminal.
